(19) United States
(12) Patent Application Publication
(10) Pub. No.: US 2026/0089809 A1
(43) Pub. Date: Mar. 26, 2026

(54) CONTROL METHOD FOR HEATING DEVICE AND REFRIGERATOR HAVING THE HEATING DEVICE

(71) Applicants: QINGDAO HAIER REFRIGERATOR CO., LTD., Qingdao (CN); HAIER SMART HOME CO., LTD., Qingdao (CN)

(72) Inventors: Yonghao LIU, Qingdao (CN); Lisheng JI, Qingdao (CN); Zhiqiang HAN, Qingdao (CN); Jianquan CHEN, Qingdao (CN)

(21) Appl. No.: 18/993,945

(22) PCT Filed: Jan. 18, 2024
(86) PCT No.: PCT/CN2024/072996

§ 371 Date: Dec. 9, 2025

(30) Foreign Application Priority Data
Jan. 19, 2023 (CN) 202310081005.0

(51) Int. Cl. H05B 6/06; H05B 6/68

(52) U.S. Cl. CPC H05B 6/06; H05B 6/686

(57) ABSTRACT

A control method for a heating device includes a heating chamber for accommodating an object to be processed, and an electromagnetic wave generating system at least partially disposed within the heating chamber or reaching the heating chamber. The electromagnetic wave generating system includes a frequency source for generating electromagnetic wave signals and a power amplifier. The control method includes determining the working efficiency of the power amplifier based on the frequency of the electromagnetic wave signal, where the working efficiency is the ratio of the output power output by the power amplifier to the input power input to the power amplifier; adjusting the output power according to the working efficiency, such that the heat output of the power amplifier is less than or equal to a preset heat threshold, where the heat output is the difference between the input power and the output power.

### CROSS-REFERENCE TO RELATED APPLICATIONS

The present application is a national phase entry of International Application No. PCT/CN2024/072996, filed Jan. 18, 2024, which claims priority to Chinese Patent Application No. 202310081005.0, filed Jan. 19, 2023, which are incorporated herein by reference in their entirety.

### TECHNICAL FIELD

The present application relates to the field of refrigeration and freezing, and particularly to a control method for a heating device and a refrigerator comprise the heating device.

### BACKGROUND

In the prior art, there exist some refrigeration and freezing devices that utilize an electromagnetic wave generating system to generate electromagnetic waves for defrosting food within storage compartments. However, during operation, some electrical components of the electromagnetic wave, particularly the power amplifier, generating system generate a significant amount of heat, which not only affects the utilization of the surrounding environment, the defrosting effect, the continuous operating time of the electromagnetic wave generating system, and the service life of the heat-generating electrical components, but also leads to energy waste.

Reference to any prior art in the specification is not, and should not be taken as, an acknowledgment or any form of suggestion that this prior art forms part of the common general knowledge in US or any other jurisdiction or that this prior art could reasonably be expected to be understood and regarded as relevant by a person skilled in the art.

### SUMMARY

A first object of the present application is to overcome at least one technical defect in the prior art, and providing a control method for the heating device.

A further objective of the first aspect of the present invention is to reduce production and operational costs.

Another further objective of the first aspect of the present invention is to improve defrosting efficiency.

An objective of the second aspect of the present invention is to provide a refrigerator equipped with the heating device.

The present application provides a control method for a heating device, the heating device comprising a heating chamber for accommodating an object to be processed, and an electromagnetic wave generating system, the electromagnetic wave generating system at least partially disposed within the heating chamber or reaching the heating chamber, the electromagnetic wave generating system comprising a frequency source for generating an electromagnetic wave signal, and a power amplifier for amplifying the power of the electromagnetic wave signal; wherein the control method comprises:
Step A: determining a working efficiency of the power amplifier based on a frequency of the electromagnetic wave signal, the working efficiency being a ratio of an output power output by the power amplifier to an input power input to the power amplifier;
Step B: adjusting the output power based on the working efficiency, such that a heat output of the power amplifier is less than or equal to a preset heat threshold, the heat output being the difference between the input power and the output power.

Optionally, an alternative frequency range of the electromagnetic wave signal is 350 MHz to 500 MHz; and
the working efficiency is negatively correlated with the frequency of the electromagnetic wave signal.

Optionally, wherein the heating device further comprises a dissipating fan for dissipating heat for the power amplifier, and wherein:
the Step A is executed, when the heating device is used for defrosting and a defrosting progress of the object to be processed is in a first stage since the start of defrosting; and
in the Step B, the dissipating fan is controlled to rotate at a preset first rotational speed, and the output power is adjusted, such that the heat output of the power amplifier equals the preset heat threshold.

Optionally, further comprising:
Step C: controlling the dissipating fan to rotate at a preset second rotational speed and adjusting the output power to a preset uniform temperature power, when the defrosting progress of the object to be processed is in a second stage, the second stage is later than the first stage; wherein,
the second rotational speed is less than the first rotational speed.

Optionally, further comprising:
Step D: controlling the electromagnetic wave generating system to adjust the frequency of the electromagnetic wave, generated by the electromagnetic wave generating system, within a preset alternative frequency range, to a turning point, the reflection parameter of the electromagnetic wave concaves at the turning point, and determining the frequency corresponding to the turning point as an initial frequency for defrosting the object to be processed;
Step E: determining a total defrosting time for the object to be processed based on the initial frequency; wherein,
the total defrosting time is negatively correlated with the initial frequency; and
the defrosting progress is a ratio of the elapsed defrosting time to the total defrosting time, and the first stage and the second stage are demarcated by the ratio.

Optionally, wherein the Step D comprises:
Step D1: controlling the electromagnetic wave generating system to adjust the frequency of the electromagnetic wave, generated by the electromagnetic wave generating system, within the alternative frequency range in steps of a preset first step size, obtaining the reflection parameter corresponding to each frequency, generated by the electromagnetic wave generating system, and determining a reference frequency based on the reflection parameter;
Step D2: controlling the electromagnetic wave generating system to adjust the frequency of the electromagnetic wave, generated by the electromagnetic wave generating system, within a selected frequency range in steps of a preset second step size, obtaining the reflection parameter corresponding to each frequency generated by the electromagnetic wave generating system, and determining an optimal frequency as the initial frequency based on the reflection parameter; wherein
the selected frequency range is a frequency within a radius based on the reference frequency in terms of an absolute value of the first step size as the radius;
and an absolute value of the second step size is less than the absolute value of the first step size.

Optionally, wherein: in Step D1, the electromagnetic wave generating system is controlled to adjust the frequency of the electromagnetic wave, generated by the electromagnetic wave generating system, to the reflection parameter is less than a preset first reflection threshold, and the frequency with the reflection parameter less than the first reflection threshold is determined as the reference frequency; and/or
in Step D2, a search direction from the reference frequency towards higher or lower frequencies is first determined, and the electromagnetic wave generating system is further controlled to adjust the frequency of the electromagnetic wave, generated by the electromagnetic wave generating system, in the search direction to a turning point, the reflection parameter of the electromagnetic wave concaves at the turning point.

Optionally, further comprising:
Step F: controlling the electromagnetic wave generating system to adjust the frequency of the electromagnetic wave, generated by the electromagnetic wave generating system, to satisfy a preset matching condition, when a preset frequency modulation condition is met; wherein,
in the Step F, the electromagnetic wave generating system is controlled to adjust the frequency starting from a current frequency towards a lower frequency direction.

This application provides a refrigerator comprising:
a cabinet defining at least one storage compartment;
a heating device comprising a heating chamber disposed within one of the storage compartments, and an electromagnetic wave generating system, the electromagnetic wave generating system at least partially disposed within the heating chamber or reaching the heating chamber, the electromagnetic wave generating system comprising a frequency source for generating an electromagnetic wave signal, and a power amplifier for amplifying the power of the electromagnetic wave signal; and
a controller configured to execute the control method of any embodiment.

Optionally, wherein the power amplifier comprises:
a primary amplification circuit for amplifying the power of the electromagnetic wave signal;
a secondary amplification circuit for amplifying the power of the output signal of the primary amplification circuit, the secondary amplification circuit connected to the output of the primary amplification circuit;
a filter circuit for filtering out higher harmonics, the filter circuit connected to the secondary amplification circuit;
a primary matching circuit connected to the input of the primary amplification circuit, and the primary matching circuit configured to achieve impedance matching between the primary amplification circuit and the electromagnetic wave signal;
a secondary matching circuit connected in series between the primary amplification circuit and the secondary amplification circuit, and the secondary matching circuit configured to achieve impedance matching between the secondary amplification circuit and the output signal of the primary amplification circuit; and
a final matching circuit connected in series between the secondary amplification circuit and the filter circuit, and the final matching circuit configured to achieve impedance matching between the filter circuit and the transmission line connected to the output of the power amplifier and the output signal of the secondary amplification circuit; wherein the primary amplification circuit and the secondary amplification circuit each comprise:
a transistor;
a bias section connected to a gate of the transistor, and the bias section is used for generating a DC bias signal to the transistor, to enable the transistor to amplify the electromagnetic wave signal; and
a power supply section connected to the drain of the transistor for supplying power to the transistor;
wherein the bias section comprises:
a plurality of first decoupling capacitors, one end of the plurality of first decoupling capacitors connected to the DC bias signal and the other end grounded;
a first choke inductor connected to the DC bias signal; and
an isolation resistor connected in series between the first choke inductor and the gate of the transistor;
and the power supply section comprises:
a plurality of second decoupling capacitors, one end of the plurality of second decoupling capacitors connected to a power supply voltage signal and the other end grounded;
a second choke inductor, one end of the second choke inductor connected to the power supply voltage signal and the other end connected to the drain of the transistor;
wherein the DC bias signal of the bias section of the primary amplification circuit is adjustable, for regulating the output power of the power amplifier;
and the DC bias signal of the bias section of the secondary amplification circuit is fixed.

The present application determining the working efficiency of the power amplifier based on the frequency of the electromagnetic wave signal, and adjusting the output power of the power amplifier according to the working efficiency, such that the heat output of the power amplifier is less than or equal to a preset heat threshold. This not only reduces the impact on the environment around the power amplifier, extends the service life and continuous operating time of the power amplifier, but also enhances the flexibility in selecting a dissipating device for dissipating heat from the power amplifier, thereby reducing the production cost of the heating device.

Furthermore, the present application controlling the dissipating fan to rotate at a high speed during the first stage of defrosting, and adjusting the output power of the power amplifier such that the heat output of the power amplifier equals the preset heat threshold. During the second stage of defrosting, the dissipating fan is controlled to rotate at a low speed, and the output power of the power amplifier is adjusted to a preset uniform temperature power. This not only meets the dissipating requirements but also improves the defrosting efficiency, fully utilizing energy, and avoids local overheating of the object to be processed, thereby enhancing the temperature uniformity of the object to be processed.

Moreover, the present application determining the total defrosting time for the object to be processed based on the initial frequency, and searching with a larger step size to determine a reference frequency that represents a rough position of the optimal frequency, then searching with a smaller step size near the reference frequency to determine the optimal frequency as the initial frequency. This not only avoids excessive defrosting of the object to be processed but also, compared to the prior art method of determining the optimal frequency by traversing all frequencies, significantly improves the efficiency of determining the optimal frequency, thereby reducing the total heating time and unnecessary energy consumption, and enhancing the energy efficiency ratio of the heating device.

The above and other objects, advantages, and features of the present application will become more apparent to those skilled in the art from the detailed description of specific embodiments of the present application, which are described below with reference to the accompanying drawings.

As used herein, except where the context clearly requires otherwise, the term “comprise” and variations of the term, such as “comprising”, “comprises” and “comprised”, are not intended to exclude further features, components, integers or steps.

### BRIEF DESCRIPTION OF DRAWINGS

The following description, with reference to the accompanying drawings, provides examples and is not intended to limit the scope of the present application. The same reference numerals in the drawings denote the same or similar components or parts. Those skilled in the art should understand that the drawings may not be drawn to scale. The drawings include:

FIG. 1 is an illustrative cross-sectional view of a refrigerator according to an embodiment of the present application;

FIG. 2 is an illustrative structural diagram of a heating device according to an embodiment of the present application;

FIG. 3 is an illustrative partial cross-sectional view of the refrigerator shown in FIG. 1 taken along a horizontal plane;

FIG. 4 is an illustrative structural diagram of a power amplifier according to an embodiment of the present application;

FIG. 5 is an illustrative circuit diagram of the primary amplification circuit, secondary amplification circuit, and corresponding matching circuits in FIG. 4;

FIG. 6 is an illustrative circuit diagram of the final matching circuit, filter circuit, and coupling circuit in FIG. 4;

FIG. 7 is an illustrative flowchart of a control method for a defrosting device according to an embodiment of the present application;

FIG. 8 is an illustrative detailed flowchart of a control method for a defrosting device according to an embodiment of the present application.

### DETAILED DESCRIPTION OF THE PRESENT INVENTION

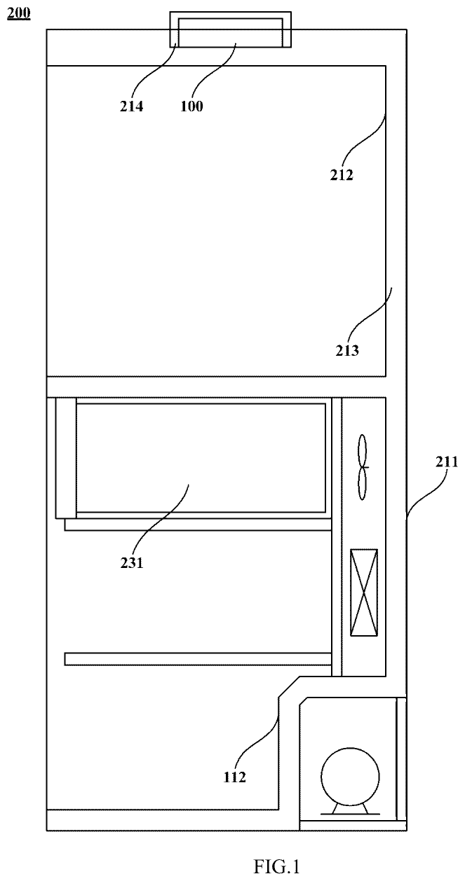

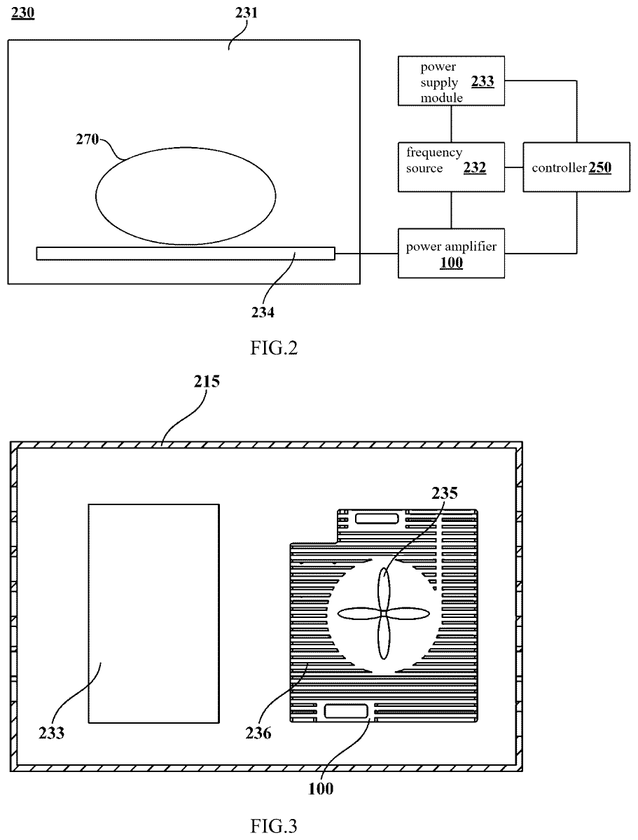

FIG. 1 is an illustrative cross-sectional view of a refrigerator 200 according to an embodiment of the present application; FIG. 2 is an illustrative structural diagram of a heating device 230 according to an embodiment of the present application. Referring to FIGS. 1 and 2, the refrigerator 200 may include a cabinet defining at least one storage compartment, at least one door for opening and closing the storage compartments, a refrigeration system for providing cooling to the storage compartments, and a heating device 230. In the present application, “at least one” refers to one, two, or more.

The cabinet may include an outer cabinet 211, at least one inner liner 212 disposed within the outer cabinet 211, and insulating material 213 disposed between the outer cabinet 211 and the inner liner 212. Each inner liner 212 defines a storage compartment.

The refrigeration system may include a compressor, a condenser, a throttling element, and at least one evaporator to provide cooling to one or more storage compartments.

The heating device 230 may include a heating chamber 231 and an electromagnetic wave generating system. The heating chamber 231 may be disposed within a storage compartment for accommodating and heating an object to be processed 270.

The electromagnetic wave generating system may be at least partially disposed within the heating chamber 231 or reach the heating chamber 231 to heat the object to be processed 270 via electromagnetic waves.

The electromagnetic wave generating system may include a frequency source 232, a power amplifier 100, a radiation antenna 234, and a power supply module 233. The frequency source 232 may be configured to generate electromagnetic wave signals.

The power amplifier 100 may be connected to the frequency source 232 to amplify the power of the electromagnetic wave signals.

The radiation antenna 234 may be disposed within the heating chamber 231, and the radiation antenna 234 electrically connected to the power amplifier 100, to radiate the amplified electromagnetic waves into the heating chamber 231.

The power supply module 233 may be electrically connected to the frequency source 232 and the power amplifier 100 to provide electrical power to the frequency source 232 and the power amplifier 100.

FIG. 3 is an illustrative partial cross-sectional view of the refrigerator 200 shown in FIG. 1 taken along a horizontal plane. Referring to FIGS. 1 and 3, the top of the outer cabinet 211 may form a downwardly recessed receiving slot 214. The signal source, power amplifier 100, and power supply module may be disposed within the receiving slot 214, to improve heat dissipation efficiency and reduce the impact on the storage compartment.

In some embodiments, the heating device 230 may further include a dissipating fan 235. The dissipating fan 235 may be disposed above the power amplifier 100 to dissipate heat for the power amplifier 100.

The dissipating fan 235 may be configured to draw air from above and direct the air along the upper surface of the power amplifier 100.

The top of the power amplifier 100 may be provided with heat sink fins 236. The heat sink fins 236 may be thermally connected to the power amplifier 100 to enhance heat dissipation efficiency and define the flow direction of the air.

The refrigerator 200 may further comprise a cover 215 disposed above the cabinet. The cover 215 may confine the signal source, power amplifier 100, power supply module, and heat sink fins 236 between the cover 215 and the cabinet to enhance safety. The cover 215 may be provided with ventilation holes to allow air to flow in and out.

In other embodiments, the heating device 230 may use other heat dissipation devices such as heat pipes or refrigerant pipes to dissipate heat for the power amplifier 100.

FIG. 4 is an illustrative structural diagram of the power amplifier 100 according to an embodiment of the present application. Referring to FIG. 4, the power amplifier 100 may comprise a primary amplification circuit 110, a secondary amplification circuit 120, a filter circuit 130, a primary matching circuit 140, a secondary matching circuit 150, and a final matching circuit 160.

Specifically, the primary amplification circuit 110 may be used to amplify the power of the electromagnetic wave signal. The secondary amplification circuit 120 may be connected to the output of the primary amplification circuit 110 to amplify the power of the output signal of the primary amplification circuit 110.

The filter circuit 130 may be connected to the secondary amplification circuit 120 to filter out higher harmonics and reduce interference with other electrical components.

The primary matching circuit 140 may be connected to the input of the primary amplification circuit 110 and configured to achieve impedance matching between the primary amplification circuit 110 and the electromagnetic wave signal.

The secondary matching circuit 150 may be connected in series between the primary amplification circuit 110 and the secondary amplification circuit 120, and configured to achieve impedance matching between the secondary amplification circuit 120 and the output signal of the primary amplification circuit 110.

The final matching circuit 160 may be connected in series between the secondary amplification circuit 120 and the filter circuit 130, and configured to achieve impedance matching between the filter circuit 130 and the transmission line connected to the output of the power amplifier 100 and the output signal of the secondary amplification circuit 120.

The power amplifier 100 of the present application comprises multiple amplification circuits, the filter circuit 130, and multiple matching circuits, which not only provide a wide range of power adjustment and allow flexible frequency adjustment for different types and states of objects to be processed 270250 to improve heating effects, but also reduce signal interference with other electrical components, thereby increasing the output power of each amplification circuit and the filter circuit 130, and reducing reflections returning to the upstream circuits, thus enhancing the output power at the output of the power amplifier 100 and the service life of the amplification circuits (especially transistors).

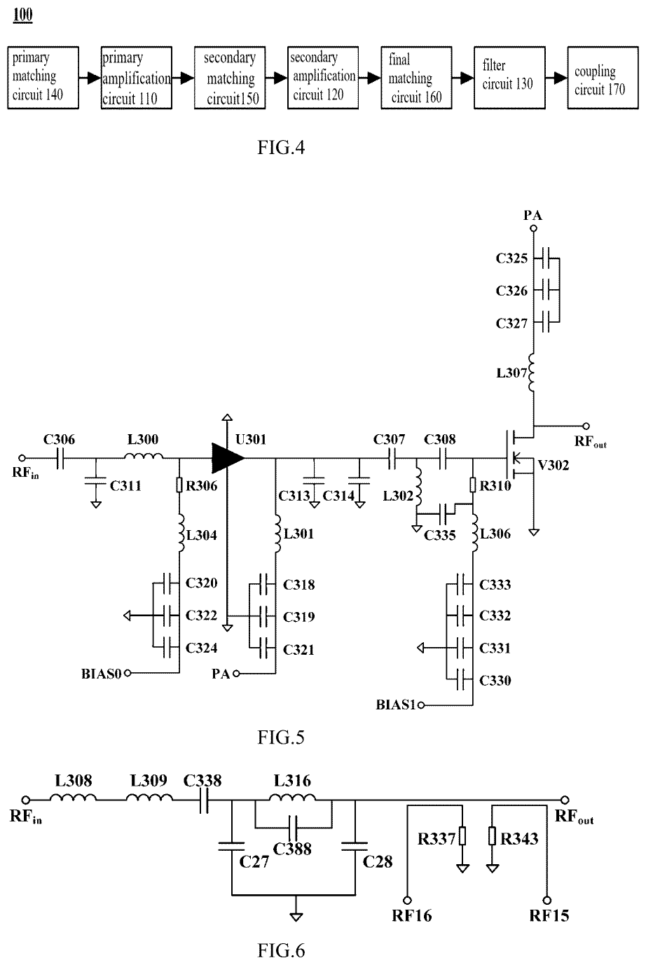

FIG. 5 is an illustrative circuit diagram of the primary amplification circuit 110, secondary amplification circuit 120, and corresponding matching circuits in FIG. 4 (in FIGS. 5 and 6, “RFin” represents the “electromagnetic wave input signal”; “RFout” represents the “electromagnetic wave output signal”). Referring to FIG. 5, the primary amplification circuit 110 and the secondary amplification circuit 120 each comprise a transistor, a bias section, and a power supply section.

The bias section may be connected to the gate of the transistor to generate a DC bias signal BIAS0 to the transistor, enabling the transistor to amplify the electromagnetic wave signal.

The power supply section may be connected to the drain of the transistor to supply power to the transistor.

The bias section of the primary amplification circuit 110 may include multiple first decoupling capacitors, a first choke inductor L304, and an isolation resistor R306.

Multiple first decoupling capacitors of the primary amplification circuit 110 may have one end connected to the DC bias signal BIAS0 and the other end grounded to reduce high-frequency components in the DC bias signal BIAS0.

In the illustrated embodiment, the multiple first decoupling capacitors of the primary amplification circuit 110 may comprise capacitors C320, C322, and C324. The capacitors C320, C322, and C324 may have different magnitudes, with capacitance values ranging from 10 pF to 100 nF, to improve filtering effects.

The first choke inductor L304 may be connected to the DC bias signal BIAS0 to prevent high-frequency signals from entering the transistor U301.

The isolation resistor R306 may be connected in series between the first choke inductor L304 and the gate of the transistor U301 to reduce the impedance impact of the DC bias signal BIAS0 on the power amplifier 100, and absorb electromagnetic wave signals directed toward the isolation resistor R306.

The power supply section of the primary amplification circuit 110 may comprise multiple second decoupling capacitors and a second choke inductor L301.

The multiple second decoupling capacitors of the primary amplification circuit 110 may have one end connected to the power supply voltage signal PA and the other end grounded, to reduce high-frequency components in the power supply voltage signal PA.

In the illustrated embodiment, the multiple second decoupling capacitors of the primary amplification circuit 110 may comprise capacitors C318, C319, and C321. The capacitors C318, C319, and C321 may have different magnitudes, with capacitance values ranging from 10 pF to 100 nF, to improve filtering effects.

The second choke inductor L301 may have one end connected to the power supply voltage signal PA and the other end connected to the drain of the transistor U301, to prevent high-frequency signals from entering the transistor U301. The second choke inductor L301 may be a wire-wound inductor, a copper wire diameter greater than 1 mm to ensure filtering effects.

The bias section of the secondary amplification circuit 120 may comprise multiple first decoupling capacitors, a first choke inductor L306, and an isolation resistor R310.

The multiple first decoupling capacitors of the secondary amplification circuit 120 may have one end connected to the DC bias signal BIAS1 and the other end grounded, to reduce high-frequency components in the DC bias signal BIAS1.

In the illustrated embodiment, the multiple first decoupling capacitors of the secondary amplification circuit 120 may comprise capacitors C330, C331, C332, and C333. The capacitors C330, C331, C332, and C333 may have different magnitudes, with capacitance values ranging from 10 pF to 100 nF, to improve filtering effects.

The first choke inductor L306 may be connected to the DC bias signal BIAS1 to prevent high-frequency signals from entering the transistor V302.

The isolation resistor R310 may be connected in series between the first choke inductor L306 and the gate of the transistor V302, to reduce the impedance impact of the DC bias signal BIAS1 on the power amplifier 100 and absorb electromagnetic wave signals directed toward the isolation resistor R310.

The power supply section of the secondary amplification circuit 120 may comprise multiple second decoupling capacitors and a second choke inductor L307.

The multiple second decoupling capacitors of the secondary amplification circuit 120 may have one end connected to the power supply voltage signal PA and the other end grounded, to reduce high-frequency components in the power supply voltage signal PA.

In the illustrated embodiment, the multiple second decoupling capacitors of the secondary amplification circuit 120 may comprise capacitors C325, C326, and C327. The capacitors C325, C326, and C327 may have different magnitudes, with capacitance values ranging from 10 pF to 100 nF, to improve filtering effects.

The second choke inductor L307 may have one end connected to the power supply voltage signal PA and the other end connected to the drain of the transistor V302, to prevent high-frequency signals from entering the transistor V302. The second choke inductor L307 may be a wire-wound inductor, a copper wire diameter greater than 1 mm to ensure filtering effects.

The secondary amplification circuit 120 may further comprise a third decoupling capacitor C335. The third decoupling capacitor C335 may have one end connected between the first choke inductor L306 and the isolation resistor R310, and the other end grounded, to reduce signal strength and ensure good filtering effects.

In some further embodiments, the DC bias signal BIAS0 of the bias section of the primary amplification circuit 110 may be set to be adjustable, the DC bias signal BIAS1 of the bias section of the secondary amplification circuit 120 may be set to be fixed, to mitigate the issue of unstable electromagnetic wave signal output.

In some further embodiments, the gain ratio of the primary amplification circuit 110 may be set to be greater than or equal to 1 and less than or equal to 3, to reduce production costs.

In some further embodiments, the output power ratio between the primary amplification circuit 110 and the secondary amplification circuit 120 may be set to be between 1/20 and 1/100, to reduce production costs.

In some embodiments, the primary matching circuit 140 may comprise a first matching capacitor C306, a second matching capacitor C311, and a first matching inductor L300.

The first matching capacitor C306 may be connected to the input of the power amplifier 100. The second matching capacitor C311 may have one end connected to the first matching capacitor C306, and the other end grounded. The first matching inductor L300 may have one end connected to the first matching capacitor C306 and the other end connected to the primary amplification circuit 110.

In some embodiments, the secondary matching circuit 150 may comprise a third matching capacitor C313 and a fourth matching capacitor C314, a fifth matching capacitor C307, and a second matching inductor L302.

The third matching capacitor C313 and the fourth matching capacitor C314 may have one end connected to the primary amplification circuit 110, and the other end grounded to improve matching efficiency and reliability. The fifth matching capacitor C307 may have one end connected to the primary amplification circuit 110 and the other end connected to the secondary amplification circuit 120. The second matching inductor L302 may have one end connected to the fifth matching capacitor C307 and the other end grounded.

In other embodiments, the secondary matching circuit 150 may only comprise the third matching capacitor C313, the fifth matching capacitor C307, and the second matching inductor L302.

The third matching capacitor C313 may have one end connected to the primary amplification circuit 110 and the other end grounded. The fifth matching capacitor C307 may have one end connected to the primary amplification circuit 110 and the other end connected to the secondary amplification circuit 120. The second matching inductor L302 may have one end connected to the fifth matching capacitor C307 and the other end grounded.

FIG. 6 is an illustrative circuit diagram of the final matching circuit 160, the filter circuit 130, and the coupling circuit 170 in FIG. 4. Referring to FIG. 6, the filter circuit 130 may comprise a filter inductor L316, a filter capacitor C27 and a filter capacitor C28, and a sixth matching capacitor C388.

The filter inductor L316 may be connected in series between the final matching circuit 160 and the output of the power amplifier 100. The filter capacitor C27 and the filter capacitor C28 may have one end connected to both ends of the filter inductor L316 and the other end grounded. The sixth matching capacitor C388 may be connected in parallel with the filter inductor L316.

In some embodiments, the final matching circuit 160 may comprise a third matching inductor L308 and a fourth matching inductor L309. The third matching inductor L308 and the fourth matching inductor L309 may be connected in series between the secondary amplification circuit 120 and the filter circuit 130 to ensure matching efficiency and reduce production costs.

In some embodiments, the power amplifier 100 may further comprise a DC blocking capacitor C308 and a DC blocking capacitor C338. The DC blocking capacitor C308 and the DC blocking capacitor C338 may be connected in series between the secondary matching circuit 150 and the secondary amplification circuit 120, and between the final matching circuit 160 and the filter circuit 130, respectively, to filter out DC signals in the circuit. The fourth matching inductor L309 and the DC blocking capacitor C338 together form a series resonant circuit, which can further filter out higher harmonics to reduce interference with other electrical components.

In some embodiments, the power amplifier 100 may further comprise a coupling circuit 170. The coupling circuit 170 may be configured to detect the output power of the filter circuit 130 (i.e., the output power of the power amplifier 100) and/or the reflected power returning to the filter circuit 130.

The coupling circuit 170 may include a detection resistor R337 and a detection resistor R343, respectively used to detect the output power and/or the reflected power. The detection resistor R337 and the detection resistor R343 may be connected to the detection signal RF16 and the detection signal RF15, respectively, and the other end grounded.

The refrigerator 200 may further include a controller 250. The controller 250 may comprise a processing unit and a storage unit. The storage unit may store computer programs, which implement the control method of the present application, when executed by the processing unit.

Specifically, the controller 250 may be configured to determine the working efficiency of the power amplifier 100 based on the frequency of the electromagnetic wave signal, and adjust the output power of the power amplifier 100 according to the working efficiency, such that the heat output of the power amplifier 100 is less than or equal to a preset heat threshold. The working efficiency is a ratio of the output power output by the power amplifier 100 to the input power input to the power amplifier 100; the heat output is the difference between the input power and the output power.

The refrigerator 200 of the present application determines the working efficiency of the power amplifier 100 based on the frequency of the electromagnetic wave signal, and further adjusts the output power of the power amplifier 100 according to the working efficiency, such that the heat output of the power amplifier 100 is less than or equal to a preset heat threshold. This not only reduces the impact on the environment around the power amplifier 100, extends the service life and continuous operating time of the power amplifier 100, but also enhances the flexibility in selecting a dissipating device for dissipating heat from the power amplifier 100, thereby reducing the production cost of the heating device 230.

The output power of the power amplifier 100 can be adjusted by the DC bias signal BIAS0 of the bias section of the primary amplification circuit 110, and the input power of the power amplifier 100 changes automatically as the output power is adjusted.

The alternative frequency range of the electromagnetic wave signal may be 350 MHz to 500 MHz. Further, the alternative frequency range may be 400 MHz to 460 MHz to further improve the heating effect. The working efficiency may be negatively correlated with the frequency of the electromagnetic wave signal.

In embodiments where the power amplifier 100 is cooled by the dissipating fan 235, the controller 250 may be configured to determine the working efficiency of the power amplifier 100, and adjust the output power of the power amplifier 100 according to the working efficiency, when the heating device 230 is used for defrosting and the defrosting progress of the object to be processed 270 is in the first stage since the start of defrosting, to avoid local overheating.

The controller 250 may be configured to control the dissipating fan 235 to rotate at a preset first rotational speed and adjust the output power such that the heat output of the power amplifier 100 equals the preset heat threshold, when the heating device 230 is used for defrosting and the defrosting progress of the object to be processed 270 is in the first stage since the start of defrosting, to improve heating efficiency and reduce energy waste.

In some further embodiments, the controller 250 may be configured to control the dissipating fan 235 to rotate at a preset second rotational speed and adjust the output power to a preset uniform temperature power, when the defrosting progress of the object to be processed 270 is in the second stage, the second stage is later than the first stage, to improve the temperature uniformity of the object to be processed 270 and avoid undesirable energy waste. The second rotational speed may be less than the first rotational speed. The uniform temperature power may be 50 W to 70 W.

In some embodiments, the controller 250 may be configured to control the electromagnetic wave generating system to adjust the frequency of the electromagnetic wave, generated by the electromagnetic wave generating system, within a preset alternative frequency range, to a turning point, the reflection parameter of the electromagnetic wave concaves at the turning point; and determine the frequency corresponding to the turning point as the initial frequency for defrosting the object to be processed 270. The controller 250 may further determine the total defrosting time for the object to be processed 270 based on the initial frequency, to reduce the number of sensing elements, eliminate or minimize time deviations caused by the errors of the sensing elements themselves, ensure the accuracy of the total defrosting time, and reduce production costs. The total defrosting time may be negatively correlated with the initial frequency.

The defrosting progress may be the ratio of the elapsed defrosting time to the total defrosting time. The first stage and the second stage may be demarcated by the ratio, for example, the first stage may be when the defrosting progress is less than 50% to 60%, and the remaining is the second stage.

The controller 250 may be configured to determine a reference frequency fb for searching the optimal frequency, and then determine the optimal frequency fg suitable for heating.

Specifically, the controller 250 may be configured to control the frequency source 232 to adjust the frequency of the electromagnetic wave signal within the preset alternative frequency range, in steps of a preset first step size W1. Obtain the reflection parameter corresponding to each frequency generated by the frequency source 232, and determine the reference frequency fb based on the reflection parameter.

The controller 250 may further be configured to control the frequency source 232 to adjust the frequency of the electromagnetic wave signal within a selected frequency range in steps of a preset second step size W2. Obtain the reflection parameter corresponding to each frequency generated by the frequency source 232, and determine the optimal frequency fg as the initial frequency based on the reflection parameter. The selected frequency range may be a frequency within a radius based on the reference frequency fb in terms of the absolute value of the first step size W1.

The absolute value of the second step size W2 may be less than the absolute value of the first step size W1.

The heating device 230 of the present application determines a reference frequency by searching with a larger step size to represent a rough position of the optimal frequency, and then searches for the optimal frequency with a smaller step size near the reference frequency. Compared to the prior art method of determining the optimal frequency by traversing all frequencies, this approach can significantly improve the efficiency of determining the optimal frequency, thereby reducing the total heating time, minimizing unnecessary energy consumption, and enhancing the energy efficiency ratio of the heating device 230.

The reflection parameter may be the return loss S11. Alternatively, the reflection parameter may be the reflected power value of the electromagnetic wave signal reflected back to the power amplifier 100.

In some embodiments, the controller 250 may be configured to search for the reference frequency fb by incrementally increasing from the minimum value of the alternative frequency range. That is, the first step size W1 is a positive number.

In alternative embodiments, the controller 250 may also be configured to search for the reference frequency fb by decrementally decreasing from the maximum value of the alternative frequency range. That is, the first step size W1 is a negative number.

The absolute value of the first step size W1 may be 5 MHz to 10 MHz, for example, 5 MHz, 7 MHz, or 10 MHz.

The absolute value of the second step size W2 may be 1 MHz to 2 MHz, for example, 1 MHz, 1.5 MHz, or 2 MHz.

In some embodiments, the controller 250 may be configured to control the frequency source 232 to adjust the frequency of the electromagnetic wave signal, generated by the frequency source 232, to the reflection parameter is less than a preset first reflection threshold S1, and determine the frequency with the reflection parameter less than the first reflection threshold S1 as the reference frequency fb. That is, the controller 250 determines the frequency at which the reflection parameter first becomes less than the first reflection threshold S1 as the reference frequency fb, to achieve an accurate optimal frequency fg, while further improving the efficiency of determining the optimal frequency fg.

The first reflection threshold S1 may be −8 dB to −5 dB, for example, −8 dB, 6 dB, or −5 dB.

In some further embodiments, the controller 250 may be configured to control the heating device 230 to stop operating, when the reflection parameter corresponding to each frequency generated by the frequency source 232 is greater than the first reflection threshold S1, to avoid poor heating effects and damage to the electromagnetic wave generating system.

In some embodiments, the controller 250 may be configured to control the frequency source 232 to adjust the frequency of the electromagnetic wave signal, generated by the frequency source 232, to a turning point, the reflection parameter of the electromagnetic wave signal concaves at the turning point. and determine the frequency corresponding to the turning point as the optimal frequency fg, to achieve excellent heating effects. The reflection parameter corresponding to the frequency immediately before the optimal frequency fg and the reflection parameter corresponding to the frequency immediately after the optimal frequency fg are both greater than the reflection parameter of the optimal frequency fg (i.e., a turning point at which concaves).

The inventors of the present application creatively recognized that the reflection parameter of the electromagnetic wave generating system undergoes a sudden change at the optimal frequency fg and the reflection parameter changes in a clear pattern near the optimal frequency fg, while the reflection parameter fluctuates slightly at other frequencies. Determining the reference frequency fb based on the first reflection threshold S1 can effectively prevent misjudgment of the turning point of the optimal frequency fg, thereby improving the accuracy of the optimal frequency fg.

In some further embodiments, the controller 250 may be configured to first determine the search direction from the reference frequency fb towards higher or lower frequencies, and then further control the frequency source 232 to adjust the frequency of the electromagnetic wave signal, generated by the frequency source 232, in that search direction, until a turning point where the reflection parameter concaves.

In some exemplary embodiments, the controller 250 may be configured to obtain a reflection parameters of aa frequency that is greater than the reference frequency fb by the second step size W2, and obtain a reflection parameters of a frequency that is less than the reference frequency fb by the second step size W2, compare the magnitudes of these two reflection parameters, and determine the direction corresponding to the smaller reflection parameter as the search direction.

In some embodiments, the controller 250 may be configured to control the electromagnetic wave generating system to adjust the frequency of the electromagnetic wave, generated by the electromagnetic wave generating system, to satisfy a preset matching condition, when a preset frequency modulation condition is met, to improve heating efficiency.

The preset frequency modulation condition may be that the reflection parameter of the electromagnetic wave generating system is greater than a preset frequency modulation reflection threshold, to ensure heating efficiency.

The preset matching condition may be that the reflection parameter of the electromagnetic wave generating system has a turning point, at which concaves, and the reflection parameter is less than a preset matching reflection threshold. The controller 250 may be configured to control the frequency source 232 to generate the electromagnetic wave signal at the frequency corresponding to the turning point, to further improve heating efficiency. The matching reflection threshold may be less than the frequency modulation reflection threshold.

In some further embodiments, when the frequency modulation condition is met, the controller 250 may be configured to control the frequency source 232 to adjust the frequency starting from the current frequency towards the lower frequency direction, to shorten the frequency modulation time and improve defrosting efficiency.

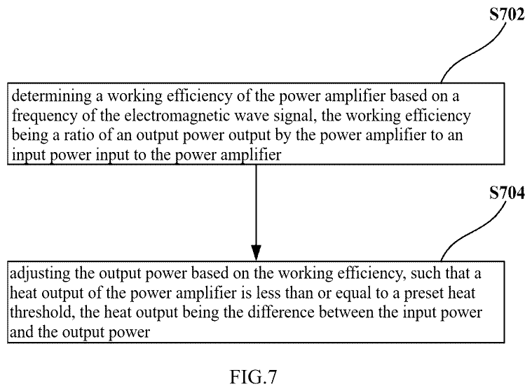

FIG. 7 is an illustrative flowchart of a control method for a defrosting device according to an embodiment of the present application. Referring to FIG. 7, the control method for a defrosting device according to the present application may include the following steps:

Step S702: Determining the working efficiency of the power amplifier 100 based on the frequency of the electromagnetic wave signal, where the working efficiency is the ratio of the output power output by the power amplifier 100 to the input power input to the power amplifier 100.

Step S704: Adjusting the output power of the power amplifier 100 according to the working efficiency, such that the heat output of the power amplifier 100 is less than or equal to a preset heat threshold, where the heat output is the difference between the input power and the output power.

The control method of the present application determines the working efficiency of the power amplifier 100 based on the frequency of the electromagnetic wave signal, and further adjusts the output power of the power amplifier 100 according to the working efficiency, such that the heat output of the power amplifier 100 is less than or equal to a preset heat threshold. This not only reduces the impact on the environment around the power amplifier 100, extends the service life and continuous operating time of the power amplifier 100, but also enhances the flexibility in selecting a cooling device for dissipating heat from the power amplifier 100, thereby reducing the production cost of the heating device 230.

The alternative frequency range of the electromagnetic wave signal may be 350 MHz to 500 MHz. Further, the alternative frequency range may be 400 MHz to 460 MHz, to further improve the heating effect. The working efficiency may be negatively correlated with the frequency of the electromagnetic wave signal.

In embodiments where the power amplifier 100 is cooled by the dissipating fan 235, Step S702 may be executed when the heating device 230 is used for defrosting, and the defrosting progress of the object to be processed 270 is in the first stage since the start of defrosting, to avoid local overheating.

In Step S704, the dissipating fan 235 may be controlled to rotate at a preset first rotational speed, and the output power may be adjusted, such that the heat output of the power amplifier 100 equals the preset heat threshold, to improve heating efficiency and reduce energy waste.

In some further embodiments, the control method of the present application may also comprise: controlling the dissipating fan 235 to rotate at a preset second rotational speed and adjusting the output power to a preset uniform temperature power, when the defrosting progress of the object to be processed 270 is in the second stage later than the first stage, to improve the temperature uniformity of the object to be processed 270 and avoid undesirable energy waste. The second rotational speed may be less than the first rotational speed. The uniform temperature power may be 50 W to 70 W.

In some embodiments, the control method of the present application may also include an initial frequency determination step: controlling the frequency source 232 to adjust the frequency of the electromagnetic wave, generated by the frequency source 232, within a preset alternative frequency range, to a turning point where the reflection parameter concaves, and determining the frequency corresponding to the turning point as the initial frequency for defrosting the object to be processed 270. The total defrosting time for the object to be processed 270 may be further determined based on the initial frequency, to reduce the number of sensing elements, eliminate or minimize time deviations caused by the errors of the sensing elements themselves, ensure the accuracy of the total defrosting time, and reduce production costs. The total defrosting time may be negatively correlated with the initial frequency.

The defrosting progress may be the ratio of the elapsed defrosting time to the total defrosting time. The first stage and the second stage may be demarcated by the ratio, for example, the first stage may be when the defrosting progress is less than 50% to 60%, and the remaining is the second stage.

The initial frequency determination step may first determine a reference frequency fb for searching the optimal frequency, and then determine the optimal frequency fg suitable for heating as the initial frequency.

Specifically, the reference frequency fb determination step may include: controlling the frequency source 232 to adjust the frequency of the electromagnetic wave signal it generates within the preset alternative frequency range in steps of a preset first step size W1, obtaining the reflection parameter corresponding to each frequency generated by the frequency source 232, and determining the reference frequency fb based on the reflection parameter.

The optimal frequency fg determination step may comprise: controlling the frequency source 232 to adjust the frequency of the electromagnetic wave signal it generates within a selected frequency range in steps of a preset second step size W2, obtaining the reflection parameter corresponding to each frequency generated by the frequency source 232, and determining the optimal frequency fg as the initial frequency based on the reflection parameter. The selected frequency range may be a frequency within a radius based on the reference frequency fb in terms of the absolute value of the first step size W1.

The absolute value of the second step size W2 may be less than the absolute value of the first step size W1.

The control method of the present application first determines a reference frequency by searching with a larger step size to represent a rough position of the optimal frequency, and then searches for the optimal frequency with a smaller step size near the reference frequency. Compared to the prior art method of determining the optimal frequency by traversing all frequencies, this approach can significantly improve the efficiency of determining the optimal frequency, thereby reducing the total heating time, minimizing unnecessary energy consumption, and enhancing the energy efficiency ratio of the heating device 230.

The reflection parameter may be the return loss S11.The reflection parameter may also be the reflected power value of the electromagnetic wave signal reflected back to the power amplifier 100.

In some embodiments, during the reference frequency fb determination step, the reference frequency fb may be searched by incrementally increasing from the minimum value of the alternative frequency range. That is, the first step size W1 is a positive number.

In alternative embodiments, during the reference frequency fb determination step, the reference frequency fb may also be searched by decrementally decreasing from the maximum value of the alternative frequency range. That is, the first step size W1 is a negative number.

The absolute value of the first step size W1 may be 5 MHz to 10 MHz, for example, 5 MHz, 7 MHz, or 10 MHz.

The absolute value of the second step size W2 may be 1 MHz to 2 MHz, for example, 1 MHz, 1.5 MHz, or 2 MHz.

In some embodiments, during the reference frequency fb determination step, the frequency source 232 may be controlled to adjust the frequency of the electromagnetic wave signal it generates to the reflection parameter is less than a preset first reflection threshold S1, and the frequency with the reflection parameter less than the first reflection threshold S1 may be determined as the reference frequency fb. That is, the frequency at which the reflection parameter first becomes less than the first reflection threshold S1 is determined as the reference frequency fb, to achieve an accurate optimal frequency fg, further improving the efficiency of determining the optimal frequency fg.

The first reflection threshold S1 may be −8 dB to −5 dB, for example, −8 dB, 6 dB, or −5 dB.

In some further embodiments, the control method of the present application may also comprise: controlling the heating device 230 to stop operating, when the reflection parameter corresponding to each frequency generated by the frequency source 232 is greater than the first reflection threshold S1, to avoid poor heating effects and damage to the electromagnetic wave generating system.

In some embodiments, during the optimal frequency fg determination step, the frequency source 232 may be controlled to adjust the frequency of the electromagnetic wave signal, generated by the frequency source 232, to a turning point where the reflection parameter of the electromagnetic wave signal concaves, and the frequency corresponding to the turning point may be determined as the optimal frequency fg, to achieve excellent heating effects. The reflection parameter corresponding to the frequency immediately before the optimal frequency fg and the reflection parameter corresponding to the frequency immediately after the optimal frequency fg are both greater than the reflection parameter of the optimal frequency fg (i.e., a turning point at which concaves).

The inventors of the present application creatively recognized that the reflection parameter of the electromagnetic wave generating system undergoes a sudden change at the optimal frequency fg and the reflection parameter changes in a clear pattern near the optimal frequency fg, while the reflection parameter fluctuates slightly at other frequencies. Determining the reference frequency fb based on the first reflection threshold S1 can effectively prevent misjudgment of the turning point of the optimal frequency fg, thereby improving the accuracy of the optimal frequency fg.

In some further embodiments, during the optimal frequency fg determination step, the search direction from the reference frequency fb towards higher or lower frequencies may be first determined, and then the frequency source 232 may be further controlled to adjust the frequency of the electromagnetic wave signal, generated by the frequency source 232, in that search direction to a turning point where the reflection parameter concaves.

In some exemplary embodiments, during the optimal frequency fg determination step, a reflection parameter of the frequency that is greater than the reference frequency fb by the second step size W2, and a reflection parameter of the frequency that is less than the reference frequency fb by the second step size W2 may be obtained, the magnitudes of these two reflection parameters may be compared, and the direction corresponding to the smaller reflection parameter may be determined as the search direction.

In some embodiments, the control method of the present application may also comprise a frequency matching step: controlling the electromagnetic wave generating system to adjust the frequency of the electromagnetic wave it generates to satisfy a preset matching condition, when a preset frequency modulation condition is met, to improve heating efficiency.

The preset frequency modulation condition may be that the reflection parameter of the electromagnetic wave generating system is greater than a preset frequency modulation reflection threshold, to ensure heating efficiency.

The preset matching condition may be that the reflection parameter of the electromagnetic wave generating system has a turning point at which concaves and the reflection parameter is less than a preset matching reflection threshold.

During the frequency matching step, the frequency source 232 may be controlled to generate the electromagnetic wave signal at the frequency corresponding to the turning point, to further improve heating efficiency. The matching reflection threshold may be less than the frequency modulation reflection threshold.

In some further embodiments, during the frequency matching step, the frequency source 232 may be controlled to adjust the frequency starting from the current frequency towards the lower frequency direction, to shorten the frequency modulation time and improve defrosting efficiency.

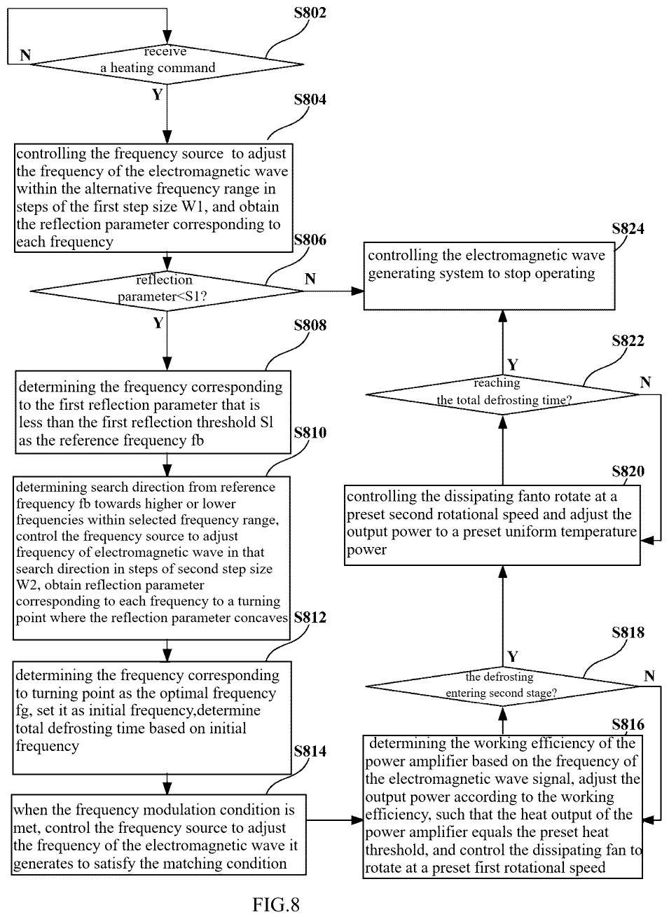

FIG. 8 is an illustrative detailed flowchart of a control method for a defrosting device according to an embodiment of the present application (in FIG. 8, “Y” represents “Yes”; “N” represents “No”). Referring to FIG. 8, the control method for a defrosting device according to the present application may also include the following detailed steps:
Step S802: Determining whether a heating command has been received. If yes, proceed to Step S804; if no, repeat Step S802.
Step S804: Controlling the frequency source 232 to adjust the frequency of the electromagnetic wave it generates within the alternative frequency range in steps of the first step size W1, and obtain the reflection parameter corresponding to each frequency.
Step S806: Determining whether there exists a reflection parameter less than a preset first reflection threshold S1. If yes, proceed to Step S808; if no, proceed to Step S824.
Step S808: Determining the frequency corresponding to the first reflection parameter that is less than the first reflection threshold S1 as the reference frequency fb.
Step S810: Determining the search direction from the reference frequency fb towards higher or lower frequencies within the selected frequency range, and further control the frequency source 232 to adjust the frequency of the electromagnetic wave it generates in that search direction in steps of the second step size W2, and obtain the reflection parameter corresponding to each frequency to a turning point where the reflection parameter concaves.
Step S812: Determining the frequency corresponding to the turning point as the optimal frequency fg and set it as the initial frequency. Determine the total defrosting time based on the initial frequency.
Step S814: When the frequency modulation condition is met, control the frequency source 232 to adjust the frequency of the electromagnetic wave it generates to satisfy the matching condition.
Step S816: Determining the working efficiency of the power amplifier 100 based on the frequency of the electromagnetic wave signal, adjust the output power according to the working efficiency, such that the heat output of the power amplifier 100 equals the preset heat threshold, and control the dissipating fan 235 to rotate at a preset first rotational speed.
Step S818: Determining whether the defrosting of the object to be processed 270 has entered the second stage. If yes, proceed to Step S820; if no, return to Step S816.
Step S820: Controlling the dissipating fan 235 to rotate at a preset second rotational speed and adjust the output power to a preset uniform temperature power.
Step S822: Determining whether the total defrosting time has been reached. If yes, proceed to Step S824; if no, proceed to Step S820.
Step S824: Controlling the electromagnetic wave generating system to stop operating.

At this point, those skilled in the art should recognize that although the present application has been fully illustrated and described through multiple exemplary embodiments, many other variations or modifications that conform to the principles of the present application can be directly determined or derived from the disclosure of the present application without departing from the spirit and scope of the present application. Therefore, the scope of the present application should be understood and considered to cover all such other variations or modifications.

1. A control method for a heating device, the heating device comprising a heating chamber for accommodating an object to be processed, and an electromagnetic wave generating system, the electromagnetic wave generating system at least partially disposed within the heating chamber or reaching the heating chamber, the electromagnetic wave generating system comprising a frequency source for generating an electromagnetic wave signal, and a power amplifier for amplifying the power of the electromagnetic wave signal; wherein the control method comprises:
Step A: determining a working efficiency of the power amplifier based on a frequency of the electromagnetic wave signal, the working efficiency being a ratio of an output power output by the power amplifier to an input power input to the power amplifier;
Step B: adjusting the output power based on the working efficiency, such that a heat output of the power amplifier is less than or equal to a preset heat threshold, the heat output being the difference between the input power and the output power.

2. The control method according to claim 1, wherein, an alternative frequency range of the electromagnetic wave signal is 350 MHz to 500 MHz; and the working efficiency is negatively correlated with the frequency of the electromagnetic wave signal.

3. The control method according to claim 1, wherein the heating device further comprises a dissipating fan for dissipating heat for the power amplifier, and wherein:
the Step A is executed, when the heating device is used for defrosting and a defrosting progress of the object to be processed is in a first stage since the start of defrosting; and
in the Step B, the dissipating fan is controlled to rotate at a preset first rotational speed, and the output power is adjusted, such that the heat output of the power amplifier equals the preset heat threshold.

4. The control method according to claim 3, further comprising:
Step C: controlling the dissipating fan to rotate at a preset second rotational speed and adjusting the output power to a preset uniform temperature power, when the defrosting progress of the object to be processed is in a second stage, the second stage is later than the first stage;
wherein the second rotational speed is less than the first rotational speed.

5. The control method according to claim 4, further comprising:
Step D: controlling the electromagnetic wave generating system to adjust the frequency of the electromagnetic wave, generated by the electromagnetic wave generating system, within a preset alternative frequency range, to a turning point, the reflection parameter of the electromagnetic wave concaves at the turning point, and determining the frequency corresponding to the turning point as an initial frequency for defrosting the object to be processed;
Step E: determining a total defrosting time for the object to be processed based on the initial frequency; wherein the total defrosting time is negatively correlated with the initial frequency; and the defrosting progress is a ratio of the elapsed defrosting time to the total defrosting time, and the first stage and the second stage are demarcated by the ratio.

6. The control method according to claim 5, wherein the Step D comprises −Step D1: controlling the electromagnetic wave generating system to adjust the frequency of the electromagnetic wave, generated by the electromagnetic wave generating system, within the alternative frequency range in steps of a preset first step size, obtaining the reflection parameter corresponding to each frequency, generated by the electromagnetic wave generating system, and determining a reference frequency based on the reflection parameter;
Step D2: controlling the electromagnetic wave generating system to adjust the frequency of the electromagnetic wave, generated by the electromagnetic wave generating system, within a selected frequency range in steps of a preset second step size, obtaining the reflection parameter corresponding to each frequency generated by the electromagnetic wave generating system, and determining an optimal frequency as the initial frequency based on the reflection parameter; wherein the selected frequency range is a frequency within a radius based on the reference frequency in terms of an absolute value of the first step size as the radius; and an absolute value of the second step size is less than the absolute value of the first step size.

7. The control method according to claim 6, wherein:
in Step D1, the electromagnetic wave generating system is controlled to adjust the frequency of the electromagnetic wave, generated by the electromagnetic wave generating system, to the reflection parameter is less than a preset first reflection threshold, and the frequency with the reflection parameter less than the first reflection threshold is determined as the reference frequency; and/or −in Step D2, a search direction from the reference frequency towards higher or lower frequencies is first determined, and the electromagnetic wave generating system is further controlled to adjust the frequency of the electromagnetic wave, generated by the electromagnetic wave generating system, in the search direction to a turning point, the reflection parameter of the electromagnetic wave concaves at the turning point.

8. The control method according to claim 1, further comprising:
Step F: controlling the electromagnetic wave generating system to adjust the frequency of the electromagnetic wave, generated by the electromagnetic wave generating system, to satisfy a preset matching condition, when a preset frequency modulation condition is met; wherein, −in the Step F, the electromagnetic wave generating system is controlled to adjust the frequency starting from a current frequency towards a lower frequency direction.

9. A refrigerator comprising:
a cabinet defining at least one storage compartment;
a heating device comprising a heating chamber disposed within one of the storage compartments, and an electromagnetic wave generating system, the electromagnetic wave generating system at least partially disposed within the heating chamber or reaching the heating chamber, the electromagnetic wave generating system comprising a frequency source for generating an electromagnetic wave signal, and a power amplifier for amplifying the power of the electromagnetic wave signal; and
a controller configured to execute the control methods according to claim 1.

10. The refrigerator according to claim 9, wherein the power amplifier comprises:
a primary amplification circuit for amplifying the power of the electromagnetic wave signal;
a secondary amplification circuit for amplifying the power of the output signal of the primary amplification circuit, the secondary amplification circuit connected to the output of the primary amplification circuit;
a filter circuit for filtering out higher harmonics, the filter circuit connected to the secondary amplification circuit; a primary matching circuit connected to the input of the primary amplification circuit, and the primary matching circuit configured to achieve impedance matching between the primary amplification circuit and the electromagnetic wave signal;
a secondary matching circuit connected in series between the primary amplification circuit and the secondary amplification circuit, and the secondary matching circuit configured to achieve impedance matching between the secondary amplification circuit and the output signal of the primary amplification circuit; and
a final matching circuit connected in series between the secondary amplification circuit and the filter circuit, and the final matching circuit configured to achieve impedance matching between the filter circuit and the transmission line connected to the output of the power amplifier and the output signal of the secondary amplification circuit;
wherein the primary amplification circuit and the secondary amplification circuit each comprise:
a transistor;
a bias section connected to a gate of the transistor, and the bias section is used for generating a DC bias signal to the transistor, to enable the transistor to amplify the electromagnetic wave signal; and
a power supply section connected to the drain of the transistor for supplying power to the transistor;
wherein the bias section comprises:
a plurality of first decoupling capacitors, one end of the plurality of first decoupling capacitors connected to the DC bias signal and the other end grounded;
a first choke inductor connected to the DC bias signal; and
an isolation resistor connected in series between the first choke inductor and the gate of the transistor;
and the power supply section comprises:
a plurality of second decoupling capacitors, one end of the plurality of second decoupling capacitors connected to a power supply voltage signal and the other end grounded;
a second choke inductor, one end of the second choke inductor connected to the power supply voltage signal and the other end connected to the drain of the transistor;
wherein the DC bias signal of the bias section of the primary amplification circuit is adjustable, for regulating the output power of the power amplifier;
and the DC bias signal of the bias section of the secondary amplification circuit is fixed.
